(19) United States
(12) Patent Application Publication
(10) Pub. No.: US 2023/0356123 A1
(43) Pub. Date: Nov. 9, 2023

(54) A MULTI-LAYERED REPLACEABLE FILTER ASSEMBLY AND A MICROFILTER ASSEMBLY IMPLIED WITH BATTERY POWERED SUCTION FAN

(71) Applicants: Ashok Shukla, Noida (IN); Pushpa Rani Shukla, Noida (IN)

(72) Inventors: Ashok Shukla, Noida (IN); Pushpa Rani Shukla, Noida (IN)

(21) Appl. No.: 18/028,694

(22) PCT Filed: Sep. 27, 2021
(86) PCT No.: PCT/IN2021/050942

§ 371 Date: Mar. 27, 2023

(30) Foreign Application Priority Data
Sep. 25, 2020 (IN) 202011041818

(51) Int. Cl. B01D 39/16; B01D 39/10; B01D 46/00; B01D 46/54; B01D 46/46

(52) U.S. Cl. CPC B01D 39/1607; B01D 39/10; B01D 46/0049; B01D 46/543; B01D 46/0086; B01D 46/46; B01D 2273/30; B01D 2279/65; B01D 2239/0442; B01D 2239/0407; B01D 2239/0631; B01D 2239/025; B01D 2239/0618; B01D 2239/065

(57) ABSTRACT

A multi-layered replaceable filter assembly (100) and a microfilter assembly (200) for providing safety from external exposure. The multi-layered micro filter assembly includes plurality of filter membranes. A first filter membrane (104) prevents particles greater than 10 micron from entering the multi-layered replaceable filter assembly (100). A second filter membrane (106) has embedded activated carbon that destroys micro-organisms including viruses and bacteria. As we go further downstream, the fiber density per cm keeps increasing with the filter membranes. A fifth filter membrane (112) made up of a combination of crabyon fiber and electro-spun nano fibers provides comfort and anti-allergic effect. A sixth filter membrane (114) lowers the velocity of air that occurs from breathing and a method thereof.

### FIELD OF INVENTION

The present disclosure generally relates to micro filter assemblies. More specifically, the present disclosure relates to an ultra-light anti-pathogenic micro filter assembly implied with battery powered micro suction fan to be implemented with protection head gears and also with PPE kits optionally, including replaceable filter layers for providing safety from external gas and liquid exposure of pathogenic loads.

### BACKGROUND OF THE INVENTION

It is known that over the last few years, globalization has severely affected the environment; causing an imbalance in the ecosystem and depleting the natural resources at an increasingly high rate.

Since time immemorial humans have fallen ill due to different causal organisms. Most of them are microscopic for example bacteria, fungi, viruses. Over the past few decades, there has been a drastic rise in harmful and fatal microbial and viral infections due to urbanization. The advent of Russian flu in the late 19th century and Spanish flu in the early 20th century caused a worldwide uproar with respect to pandemics that spread through air and via direct contact as well. The recent COVID-19 pandemic once again made humanity realize that it cannot carry on its current way of living and development. Therefore, in order to avoid contamination and spread of microbial and viral infections, several shields and wearables have been introduced in the market. Such shields and wearables include head shields, masks, gloves, and PPE kits. Furthermore, there are filters attached to conventional shields and masks to protect humans from such diseases.

However, there are limitations with the efficiency in restricting viruses and comfortability in wearing these devices for prolonged hours. Moreover, there are limitations with the efficiency of protection conferred by conventional filters. The earliest material used as a filter was a cloth mask. They had to be washed daily and were inefficient to high pathogenic loads. Increasing the number of layers did increase the efficacy to some extent but viral aerosols range from micro to nanometers in size and hence are difficult to stop from spreading around. These filters were also unable to filter out the harmful gases from nasal and oral passage.

Therefore, there is a need to overcome the limitations related with the conventional micro-filter's assemblies.

### SUMMARY OF THE INVENTION

In one aspect of the invention, a multi-layered replaceable filter assembly (100) is provided.

In another aspect of the invention, the multi-layered replaceable filter assembly (100) for filtering air including a first filter membrane (104) positioned at the outermost side of the multi-layered replaceable filter assembly (100), a second filter membrane (106) positioned downstream to the first filter membrane (104), a third filter membrane (108) positioned downstream to the second filter membrane (106), a fourth filter membrane (110) positioned downstream to the third filter membrane (108), a fifth filter membrane (112) positioned downstream to the fourth filter membrane (110), and a sixth filter membrane (114) positioned downstream to the fifth filter membrane (112) is provided.

In another aspect of the invention, the first filter membrane (104) made up of a fiber further comprises of a combi-HEPA filter of 1-10 micron having plurality of layers. The plurality of layers is composed of a combination of micro perforated metal or thin metal plates with randomly laid fiber fabric with fiber density of 60-100 threads/cm in warp and weft. In yet another aspect of the invention, the first filter membrane (104) further comprises of random fluidic gas circulation path trapping particles is provided.

In another aspect of the invention, the second filter membrane (106) formed of a fiber and of activated carbon particles spray loaded by deep penetration method through carrier solvent pressure atomization, avoiding consistent monomer releasing aldehydes, with chilled nitrogen grinded micro fine high surface area to weight ratio activated carbon particles having enhanced micro-organism destructive effectivity because of unsaturated orbital configuration with nature of destroying the viral and the bacterial particles chemically and making them ineffective. In yet another aspect of the invention, the second filter membrane (106) has the fiber density of 60-100 threads/cm in warp and weft is provided.

In another aspect of the invention, the third filter membrane (108) has the fiber density of 100-120 threads/cm in warp and weft to filter out any particles that may have passed through, is provided.

In yet another aspect of the invention, the fourth filter membrane (110) is made up of a fiber with the fiber density of 120-140 threads/cm in warp and weft is provided.

In yet another aspect of the invention, the fifth filter membrane (112) that is anti-flow is formed from a combination of crabyon and electro-spun nano fibers with the fiber density of 140-160 threads/cm in warp and weft having anti-microbial and anti-allergic activity, is provided.

In yet another aspect of the invention, the replaceable filter layers for providing safety from external gas and liquid exposure of pathogenic loads is provided.

In yet another aspect of the invention, the filters of the multi-layered replaceable filter assembly (100), are made of fiber selected from a group comprising but not limited to cotton, rayon, silk, nylon, hemp, alpaca fiber, wool, jute, polyacrylic fibers, polyethylene terephthalate, poly butylene terephthalate, poly vinyl chloride, and viscose and a combination thereof.

In yet another aspect of the invention, the sixth filter membrane (114) comprises a needle punched non-woven soft fibers with the fiber density of 160-180 threads/cm in warp and weft to increase breathing comfort.

In another aspect of the invention, a microfilter assembly (200) is provided.

In yet another aspect of the invention, the microfilter assembly (200) for filtering air including a casing (201) to house a multi-layered replaceable filter assembly (100), a mesh (202) to allow air inlet, a door (203) to open the microfilter assembly (200), a lock (204) to lock the door (203), a plurality of filter holders (301) to hold a plurality of filters of the multi-layered replaceable filter assembly (100) in place, a microsensor connected to an alarm device (303) to sense filter clogging and indicates to change the one or plurality of the filters, a suction fan (302) to siphon the clean and filtered air inside the assembly, and a fan inlet casing (205) to protect the fan, is provided.

In yet another aspect, a method (500) for working of a microfilter assembly (200) includes sensing (502) a need for air flow by a microsensor (303), transmitting (504) the signal by the microsensor (303) relating to air flow to a control circuit in order to enable operation of suction fan (302), filtering (506) the air from the environment via a multi-layered replaceable filter assembly (100) and sensing (508) a blockage in the air passage by the microsensor (303) that raises an alarm (303).

### BRIEF DESCRIPTION OF THE DRAWINGS

The drawing/s mentioned herein disclose exemplary embodiments of the claimed invention. Other objects, features, and advantages of the present disclosure will be apparent from the following description when read with reference to the accompanying drawing.

FIG. 1 illustrates a structural view of a multi-layered replaceable filter assembly (100) for providing safety from external gas and liquid exposure of pathogenic loads, according to an embodiment herein.

FIG. 2 illustrates an isometric view of a microfilter assembly (200) for housing the multi-layered replaceable filter (100), according to an embodiment herein.

FIG. 3 illustrates a cross sectional view (300) of the microfilter assembly (200), according to an embodiment herein.

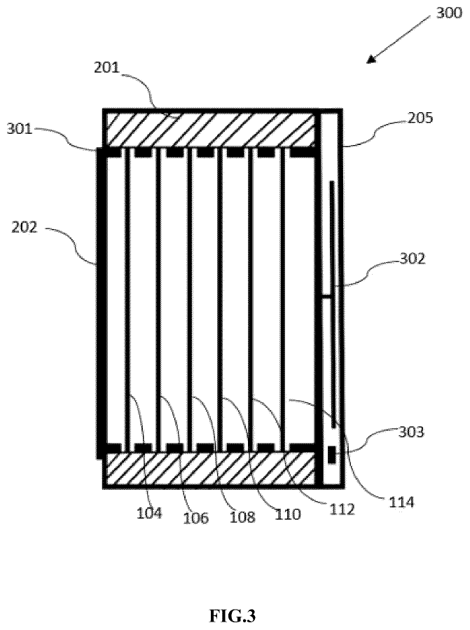

FIG. 4 illustrates a back view of the microfilter assembly (200), according to an embodiment herein.

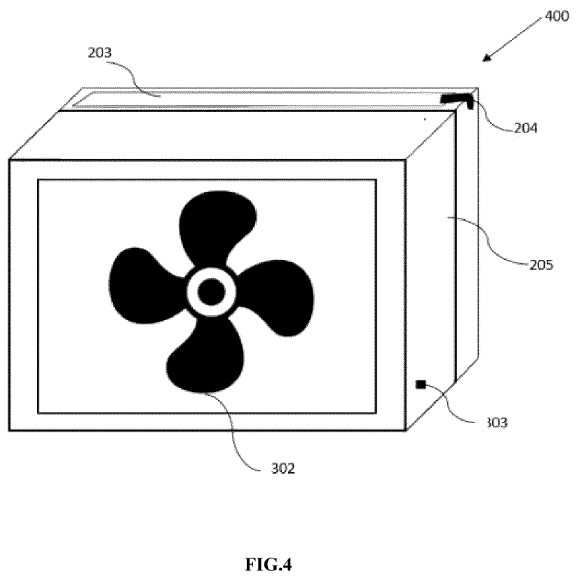

FIG. 5 illustrates a flowchart that depicts a working of the microfilter assembly (200) given in FIG. 2, according to an embodiment herein.

To facilitate understanding, like reference numerals have been used, where possible to designate like elements common to the figures.

### DETAILED DESCRIPTION OF THE PREFERRED EMBODIMENTS

This section is intended to provide explanation and description of various possible embodiments of the present disclosure. The embodiments used herein, and the various features and advantageous details thereof are explained more fully with reference to non-limiting embodiments illustrated in the accompanying drawing/s and detailed in the following description. The examples used herein are intended only to facilitate understanding of ways in which the embodiments may be practiced and to enable the person skilled in the art to practice the embodiments used herein. Also, the examples/embodiments described herein should not be construed as limiting the scope of the embodiments herein.

As mentioned, there is a need for the development of a highly efficient filter assembly that would protect humans from diseases that spread via nasal and oral tract and also from harmful gases, dust, and all types of microbial pathogenic loads. The embodiment herein overcome the limitations of the prior art by providing an ultra-light anti-pathogenic multi-layered replaceable filter (100) and a microfilter assembly (200) with replaceable filters.

The term “microsensor (303)”, “clogging alarm (303)” and “alarm (303)” are interchangeably used across the context.

The term “multi-layered replaceable filter assembly (100)” and “multi-layered filter assembly (100)” are interchangeably used across the context.

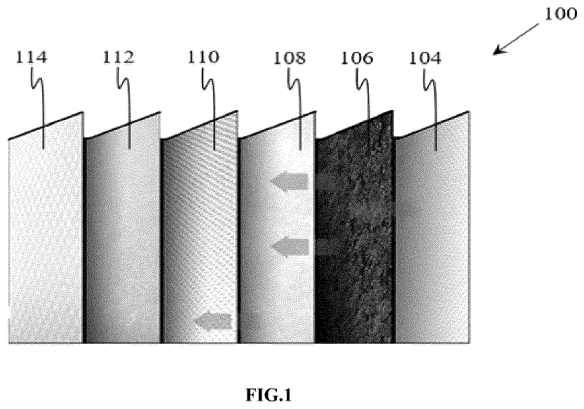

FIG. 1 illustrates a structural view of a multi-layered replaceable filter assembly (100) for providing safety from external gas and liquid exposure of pathogenic loads, according to an embodiment herein. A multi-layered replaceable filter assembly (100) is provided.

The multi-layered replaceable filter assembly (100) includes a first filter membrane (104), a second filter membrane (106), a third filter membrane (108), a fourth filter membrane (110), a fifth filter membrane (112), and a sixth filter membrane (114).

The first filter membrane (104) positioned at the outermost side of the multi-layered replaceable filter assembly (100). The second filter membrane (106) positioned downstream to the first filter membrane (104). The third filter membrane (108) positioned downstream to the second filter membrane (106). The fourth filter membrane (110) positioned downstream to the third filter membrane (108). The fifth filter membrane (112) positioned downstream to the fourth filter membrane (110). The sixth filter membrane (114) positioned downstream to the fifth filter membrane (112).

The first filter membrane (104) is the outermost layer of the multilayered filter assembly (100) that is composed of a combi-HEPA filter having multiple layers of metal films having multiple pore sizes of 1-10 microns. The multiple layers of the combi-HEPA filter are made up of a combination of micro perforated metal or thin metal plates with randomly laid fiber fabric with the fiber density of 60-100 threads/cm in warp and weft with random fluidic gas circulation path trapping particles typically trapping most of the oily particles or oil particles for example COVID-19 virus with oil surrounded surface. Furthermore, the fiber/s may include materials such as cotton or rayon or polyacryl or Polyethylene Terephthalate or Poly butylene Terephthalate or Poly Vinyl Chloride or Viscose or various other polymer types and/or a combination thereof.

The second filter membrane (106), present downstream to the first filter membrane (104), is formed of activated carbon particles spray loaded by deep penetration method through carrier solvent pressure atomization with the fiber density of 60-100 threads/cm in warp and weft. The third filter membrane (108), present downstream of the second filter membrane (106), is made up of a fiber with the fiber density of 100-120 threads/cm in warp and weft to filter out any particles that may have passed through. The fourth filter membrane (110), present downstream of the third filter membrane (108), is made up of a fiber with the fiber density of 120-140 threads/cm in warp and weft. The fifth filter membrane (112), present downstream of the fourth filter membrane (110), is made from a combination of crabyon and electro-spun nano fibers with the fiber density of 140-160 threads/cm in warp and weft having anti-microbial and anti-allergic activity. The sixth filter membrane (114), present downstream of the fifth filter membrane (112), is made of needle punched non-woven soft fibers with the fiber density of 160-180 threads/cm in warp and weft suited for the purpose of elimination of turbulent and hissing air flow to increase breathing comfort.

In another embodiment, the fiber from which the filters of the multi-layered replaceable filter assembly (100) are made are selected from a group comprising but not limited to cotton, rayon, silk, nylon, hemp, alpaca fiber, wool, jute, polyacrylic fibers, Polyethylene Terephthalate, Poly Butylene Terephthalate, Poly Vinyl Chloride, and Viscose and a combination thereof.

In another embodiment, the microperforated metal of the first filter membrane (104) is selected from a group comprising but not limited to aluminum, silver, gold, bronze, or a combination thereof.

In another embodiment, the HEPA filter of the first filter membrane (104) is selected from a group comprising but not limited to A, B, C, D, E and F HEPA filters or a combination thereof. In another embodiment, the activated carbon is selected from a group comprising granular and powdered activated carbon or a combination thereof. In another embodiment, the multi-layered replaceable filter assembly (100) is reusable. In another embodiment, the multi-layered replaceable filter assembly (100) is dyed in different colors. In another embodiment multi-layered replaceable filter assembly (100) has a microsensor attached. In another embodiment the multi-layered replaceable filter assembly (100) is made of plurality of membranes. In another embodiment the multi-layered replaceable filter assembly (100) is compatible with different types of protective headgear.

The first filter membrane (104), which is the outermost layer of the multi-layered replaceable filter assembly (100), is the first layer to come in contact with the outside environment. The first filter membrane (104) prevents particles greater than 10 micron from entering the multi-layered replaceable filter assembly (100) and traps most of the oil particles suspended in the air. The activated carbon present in the second filter membrane (106) destroys any microorganisms including viruses and bacteria that might have slipped through the first filter membrane (104). The above-mentioned activated carbon particles of the size range and barrier active atomic structure of the same capable of adsorption of not only conventional particles but various chemicals including but not limited to aldehyde adsorption mechanism which includes formaldehyde, acetaldehyde and all other aldehydes, fatty acids, alcohols and various other organic chemicals and thus enhancing the destructive capability of microorganisms including viruses. As we go further downstream, the fiber density per cm keeps increasing with the filter membranes, so as to stop all particulates that might have passed through the combi-HEPA filter present in the first filter membrane (104) but allow breathability. The combination of crabyon fiber and electro-spun nano fibers present in the fifth filter membrane (112) further provide enhanced comfort, anti-microbial effect, anti-allergic effect, azodye absorbance, aqueous absorbance, and high blending wettability property. In the second filter membrane (106) is spray loaded with activated carbon particles by deep penetration through carrier solvent pressure atomization to kill microbes by disrupting a cell membrane and viruses by chemically destroying a protein coat.

The sixth filter membrane (114) lowers the velocity of air having needle punched non-woven soft fibers especially suited for the purpose of elimination of turbulent and hissing air flow to increase breathing comfort.

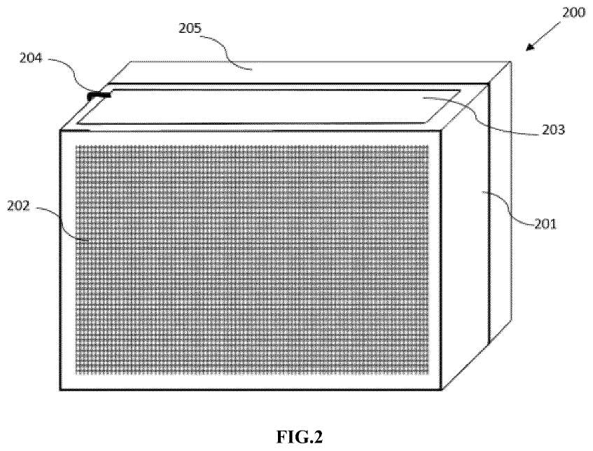

FIG. 2 illustrates a microfilter assembly (200). The microfilter assembly (200) includes a casing (201) to house a multi-layered replaceable filter assembly (100), a mesh (202) to allow air inlet, a door (203) to open the microfilter assembly (200), a lock (204) to lock the door (203), a plurality of filter holders (301) to hold a plurality of filters of the multi-layered replaceable filter assembly (100) in place, a microsensor connected to an alarm device (303) to sense filter clogging and indicates to change the one or plurality of the filters, a suction fan (302) to siphon the clean and filtered air inside the assembly, a fan inlet casing (205) to protect the fan.

The entire microfilter assembly (200) is coupled with battery powered suction fan (302), and the fan sucks the filtered and safe air through the filter layers and the filter layers clean the air of particles and pathogens etc. That way, the suction fan, getting filtered air, is not spoiled for a long time, and the person gets clean air to breathe.

In another embodiment, the microsensor (303) may be present anywhere on the microfilter assembly (200).

In another embodiment, the material from which the casing (201) is made is selected from, but not limited to, a group of all moldable materials. In another embodiment, the mesh (202) is not present in the microfilter assembly (200). In yet another embodiment, the mesh (202) is made from a material selected from, but not limited to, a group of metals, plastics, glass, and fiber or a combination thereof. In yet another embodiment, the door (203) is a sliding door. In yet another embodiment, the door (203) is connected via a hinge. In yet another embodiment, the door (203) is a magnetic door. In yet another embodiment, the microfilter assembly (200) is sealed. In yet another embodiment, the microfilter assembly (200) is installed in a building, window, vent, air-conditioner, air-purifier, automobile, hazmat suit, personal protective equipment (PPE), chemical mask, helmets, space suit, or any protective gear. In yet another embodiment, the plurality of holders is selected from a group of but not limited to clippings, screws, slide and lock mechanism or a combination thereof.

In yet another embodiment, the fan inlet casing (205) is made of, but not limited, to plastic, biodegradable plastic, bagasse, paper, bioplastic, steel, aluminum, alloy or a combination thereof. In yet another embodiment, the suction fan (302) blade is of different shapes. In yet another embodiment, the fan inlet casing (205) is of different shapes. In yet another embodiment, the suction fan (302) blades are plurality in number. In yet another embodiment, the microsensor (303) is connected to an electronic device that signals to change the filter. In yet another embodiment, a manual switch is placed just below the indicator alarm (303) which is used to bypass or switch off the alarm. In yet another embodiment, the electronic device is selected from, but not limited to, a wristwatch, a smart phone, a computer, a laptop, a tablet, an e-reader, a recorder, a smart watch, a navigator, and a camera.

In yet another embodiment, the microsensor measures an airflow rate. In yet another embodiment, the microsensor, measures a temperature of incoming air. In yet another embodiment, an electronic sensor, measures a temperature of outgoing air. In yet another embodiment, the electronic sensor measures the flow of air circulation. In yet another embodiment, the clogging alarm (303) is a bell alarm.

In yet another embodiment, the clogging alarm (303) is an LED light. In yet another embodiment, the clogging alarm (303) is a vibrating alarm. In yet another embodiment, the clogging alarm is a musical alarm. In another embodiment, the clogging alarm is a customized alarm.

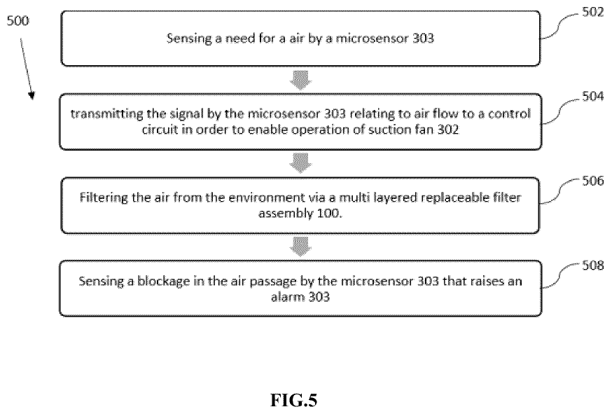

FIG. 5 illustrates a flowchart that depicts a working of the microfilter assembly (200) of FIG. 2, according to an embodiment herein. The method 500 for the working of the microfilter assembly (200) is provided.

At step (502), sensing a need for air flow by a microsensor 303. In an embodiment, the microsensor (303) is connected to an electronic device that signals to change the filter. In another embodiment, a manual switch is placed just below the indicator alarm (303) which is used to bypass or switch off the alarm. In yet another embodiment, the electronic device is selected from, but not limited to, a wristwatch, a smart phone, a computer, a laptop, a tablet, an e-reader, a recorder, a smart watch, a navigator, a camera. In yet another embodiment, the microsensor measures an airflow rate. In yet another embodiment, the microsensor, measures a temperature of incoming air. In yet another embodiment, an electronic sensor, measures a temperature of outgoing air. In yet another embodiment, the electronic sensor measures the flow of air circulation.

At step (504), transmitting an electric impulse to a suction fan (302) by the microsensor (303). In an embodiment, the suction fan (302) is connected to a power source. In another embodiment, the power source is a battery. In another embodiment, the power source is a solar power. In another embodiment, the power source is an alternating current.

15 At step (506), filtering said air from the environment via a multi-layered replaceable filter assembly (100).

At step (508), sensing a blockage in an air passage by the microsensor (303) and raises an alarm (303).

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

We claim:

1. A multi-layered replaceable filter assembly (100) comprising:
a. a first filter membrane (104) positioned at the outermost side of the multi-layered replaceable filter assembly (100);
b. a second filter membrane (106) positioned downstream to the first filter membrane (104);
c. a third filter membrane (108) positioned downstream to the second filter membrane (106);
d. a fourth filter membrane (110) positioned downstream to the third filter membrane (108);
e. a fifth filter membrane (112) positioned downstream to the fourth filter membrane (110); and
f. a sixth filter membrane (114) positioned downstream to the fifth filter membrane (112);
wherein the first filter membrane (104) is composed of a combi-HEPA filter configured to that trap oil particles and aerosols containing microbes including bacteria and virus;
wherein the second filter membrane (106) is provided with the fiber density of 60-100 threads/cm in warp and weft to actively trap solid particles, destroy bacteria and viruses, and adsorb different chemicals;
wherein the third filter membrane (108) is made up of a fiber with the fiber density of 100-120 threads/cm in warp and weft to filter out any particles that may have passed through;
wherein the fourth filter membrane (110) is made up of a fiber with the fiber density of 120-140 threads/cm in warp and weft;
wherein the fifth filter membrane (112) is made up of fibers with the fiber density of 140-160 threads/cm in warp and weft having anti-microbial and anti-allergic activity; and
wherein the sixth filter membrane (114) is made up of needle punched non-woven soft fibers with the fiber density of 160-180 threads/cm in warp and weft to increase breathing comfort.

2. The multi-layered filter assembly (100) of claim 1, wherein the first filter membrane (104) further comprising a plurality of layers made up of a combination of micro perforated metal or thin metal plates with randomly laid fiber fabric with fiber density 60-100 threads per cm in warp and weft.

3. The multi-layered filter assembly (100) of claim 1, wherein the second filter membrane (106) is spray loaded with activated carbon particles by deep penetration through carrier solvent pressure atomization to kill microbes by disrupting a cell membrane and viruses by chemically destroying a protein coat.

4. The multi-layered filter assembly (100) of claim 1, wherein the fifth filter membrane (112) is made from a combination of crabyon and electro-spun nano fibers that possess anti-microbial and anti-allergic properties.

5. The multi-layered filter assembly (100) of claim 1, wherein the fiber of the filter layers is selected from a group comprising but not limited to cotton, rayon, silk, nylon, hemp, alpaca fiber, wool, jute, polyacrylic fibers, polyethylene terephthalate, poly butylene terephthalate, poly vinyl chloride, and viscose and a combination thereof.

6. A microfilter assembly (200), the assembly comprising:
a. a casing (201) to house a multi-layered replaceable filter assembly (100);
b. a mesh (202) to allow air inlet;
c. a door (203) to open the microfilter assembly (200);
d. a lock (204) to lock the door (203);
e. a plurality of filter holders (301) to hold a plurality of filters of the multi-layered replaceable filter assembly (100) in place;
f. a microsensor connected to an alarm device (303) to sense filter clogging and indicates to change the one or plurality of the filters;
g. a suction fan (302) to siphon the clean and filtered air inside the assembly; and
h. a fan inlet casing (205) to protect the fan.

7. A method (500) for working of a micro-filter assembly (200), the method comprising:
a. sensing (502) a need for an air flow by a microsensor (303);
b. transmitting (504) the signal by the microsensor (303) relating to air flow to a control circuit in order to enable operation of suction fan (302);
c. filtering (506) said air from the environment via a multi-layered replaceable filter assembly (100); and
d. sensing (508) a blockage in an air passage by the microsensor (303) and raises an alarm (303)
